(19) United States
(12) Patent Application Publication
(10) Pub. No.: US 2005/0146870 A1
(43) Pub. Date: Jul. 7, 2005

(54) Elongated flexible lighting equipment and fabricating method of same

(76) Inventor: Jeng-shyong Wu, Hsinchu (TW)

Correspondence Address: MCGLEW & TUTTLE, PC, P.O. BOX 9227, SCARBOROUGH STATION, SCARBOROUGH, NY, 10510-9227, US

(21) Appl. No.: 10/753,178

(22) Filed: Jan. 6, 2004

(51) Int. Cl. F21S 2/00

(52) U.S. Cl. 362/227

(57) ABSTRACT

The present invention discloses an elongated flexible lighting equipment and fabrication method of same, wherein the fabrication method comprises the steps: connecting a plurality of non-vacuum or non-gas filled lighting elements in series, parallel, or series-parallel with conductors to form a string of lighting source with electrical connection means provided at its both terminals thereof, disposing a power supply basbus formed of several conductors of similar or different polarity in parallel to the string of lighting source for connecting both terminals of the string of lighting source to preformed electrodes, enclosing the string of lighting source with a soft PVC insulation material using a plastic extrusion press with a specific die block so as to form a flexible main body of lighting equipment enclosed in an insulation housing.

### BACKGROUND OF THE INVENTION

1. Field of the Invention

The present invention relates to an elongated flexible lighting equipment and fabrication method of same, and more particularly, to an elongated lighting equipment enclosed with a flexible insulated housing, and the fabricating method of same through the procedures of cascade connection, busbar installation and extrusion molding.

2. Description of the Prior Art

In a prior LED lighting equipment disclosed by U.S. Pat. No. 6,200,003B1, an individual LED is put into a canister enclosed with a housing, and then the LEDs are connected with two conductors to form a combined decorative lighting structure containing a group of LEDs. However, the lighting structure constructed as such may exhibit a good ornamental effect in single unit, it is by no means a convenient lighting equipment as a whole cascaded group due to some inherent technical limitation in connecting and fixing the individual LEDs together with their canisters enclosed in the housings which can only be grouped loosely and apt to be disorganized inadvertently. Besides, the appearance of such a LED lighting equipment will not offer the observer a visual easiness.

Aiming at the above depicted defects, the present invention is to propose a newly developed construction and fabrication method for an elongated flexible lighting equipment and fabrication method of same which can rectify the aforesaid shortcomings inherent to the prior technique.

### SUMMARY OF THE INVENTION

Accordingly, the object of the present invention is to provide an elongated flexible lighting equipment and fabrication method of same which is very easy to fabricate and the product is capable of exhibiting a variety of lighting effects.

The elongated flexible lighting equipment fabricated according to the present invention can be flexed to make desired series, parallel or series-parallel connection at random, and its substrate may be made of a transparent or, a semi-transparent material with a variety of contours so as to improve its ornamental lighting effect.

The above object and other advantages of the present invention will become more apparent by describing in detail the preferred embodiment of the present invention with reference to the attached drawing.

### BRIEF DESCRIPTION OF THE DRAWINGS

FIGS. 1A to 1E are the schematic views illustrating the fabrication steps in a first embodiment of the present invention.

FIGS. 2A to 2D are the schematic views illustrating the fabrication steps in a second embodiment of the present invention.

FIGS. 3A to 3F are the schematic views illustrating the fabrication steps in a third embodiment of the present invention.

FIG. 4 is a cross-sectional view of a fourth embodiment.

FIG. 5 is a cross-sectional view of a fifth embodiment.

FIGS. 6A and 6B are the cross-sectional views of a sixth embodiment.

FIGS. 7A and 7B are the plan views of a seventh embodiment.

FIGS. 8A and 8B are the plan views of an eighth embodiment.

FIGS. 9A and 9B are the plan views of a ninth embodiment.

FIGS. 10A to 10D are the schematic views illustrating fabrication steps in a tenth embodiment.

FIGS. 11A and 11B are the plan views of an 11^{th} embodiment.

FIGS. 12A and 12B are the plan views of a 12^{th} embodiment.

FIGS. 13A and 13B are the plan views of a 13^{th} embodiment.

FIG. 14 is a schematic view illustrating the procedure of enclosing an insulation housing on a string of lighting equipment of the present invention.

FIG. 15 is a planar view of a 14^{th} embodiment.

### DETAILED DESCRIPTION OF THE PREFERRED EMBODIMENTS

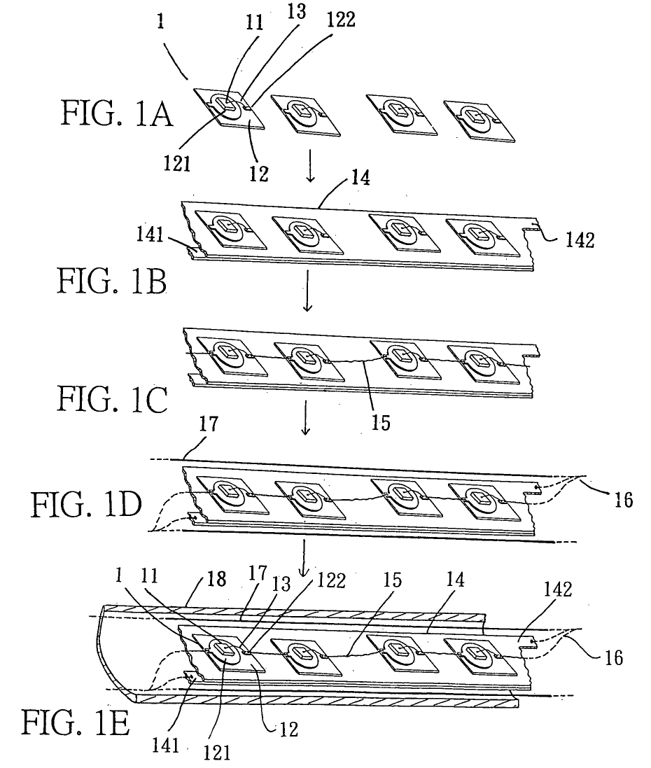

FIGS. 1A to 1E show the schematic views illustrating the fabrication steps in a first embodiment, the fabrication comprises the steps:
Step 1: Disposing LED unpacked chip or its original element in a single substrate 12 in which containing at least two electrodes, connecting one of the two to an electrode 121 of the substrate 12, and the other one to the other electrode 122 of the substrate 12 with a welding wire 13.
Step 2: Arranging longitudinally several LED lighting element 1 in an elongated LED substrate 14 which is provided with electrodes 141, 142 each at one terminal.
Step 3: Connecting several LED lighting elements 1 in cascade with a power supply busbar 15 to form a string of lighting source.
Step 4: Connecting multi-polar or multi-circuit power supply busbars 15 together with connectors 16 to form a variety of elongated lighting effects.
Step 5: Preparing another power supply busbar 17 in parallel to the power supply busbar 15.
Step 6: Enclosing the string of lighting source formed in step 3 and the busbars 15, 17 with a soft insulation housing 18 by extruding process in the longitudinal direction using a plastic extrusion press with a specific die block so as to form into a flexible main body of predetermined length,
   wherein the LED lighting element 1 is a non-vacuum type or a non-gas filled type, or may be an organic light emitting diode (OLED), electroluminescence light (EL), or an organic electroluminescence light (OEL), which can be formed into a string of lighting source with a plurality of conductors connected in series, parallel, or series-parallel being supplied power from either one terminal. The lighting elements 1 may also be disposed in the form like scattered spots, meandering lines, or spreaded planes, also they may be disposed in the figure of an array, a single plane, multi-planes, or even a three dimensional contour.

The elongated substrate 14 may be an OLED, EL or OEL formed of a soft material in elongated configuration. When its two electrodes are connected to the busbars 15, 17 with conductors, the applied voltage will be approximately equal to that applied to the terminals of the LED lighting element 1, the connecting conductors may be bare or insulated.

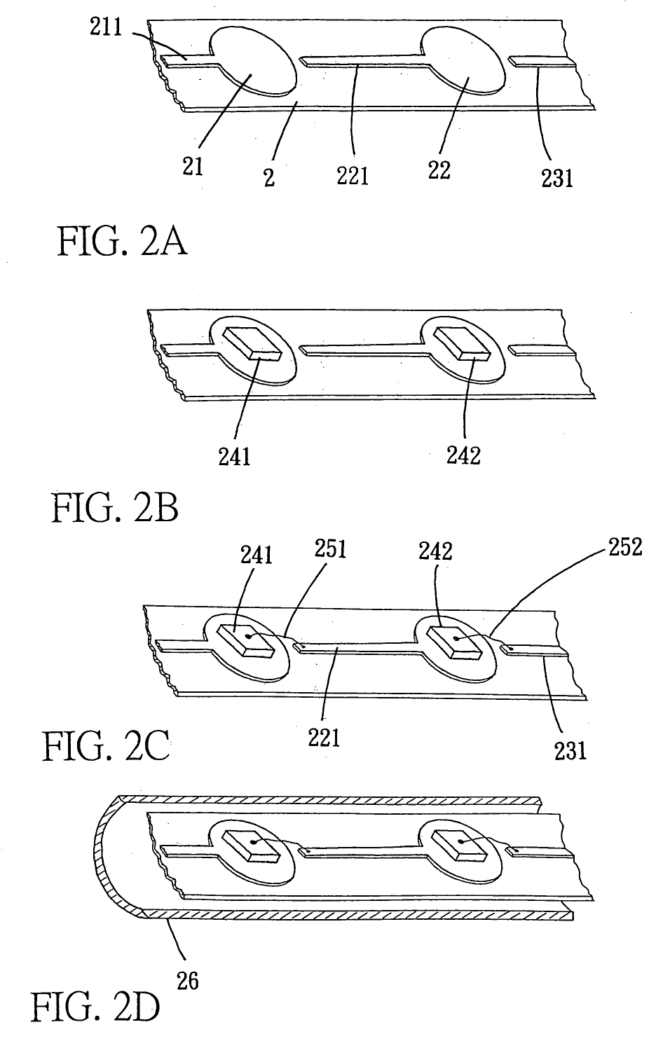

FIGS. 2A to 2D are the schematic views illustrating the fabrication steps in a second embodiment, it comprises the steps:
Step 1: Fabricating an elongated substrate 2 firstly, and then disposing several electrodes 21, 22 . . . longitudinally on the upper surface of the elongated substrate 2.
Step 2: Extending extension portion 211, 221, 231 in the same direction from each of the electrodes 21, (22) . . . , and installing a LED unpacked chip or original element 241 (242) on each electrode 21 (22) . . .
Step 3: Connecting each LED unpacked chip or original element 241(242) with the adjacent extension portion 221 (231) with a welding wire 251(252) to form a string of lighting source.
Step 4: Enclosing the string of lighting source with an inner insulation housing 26,
   wherein the elongated substrate 2 is made of an elongated soft insulated material which is a longitudinally extruded mono- or multi-colored plastic transparent, or semi-transparent material. The plastic may be either PVE or PVC, and may be filled with a fluorescent material if desired.

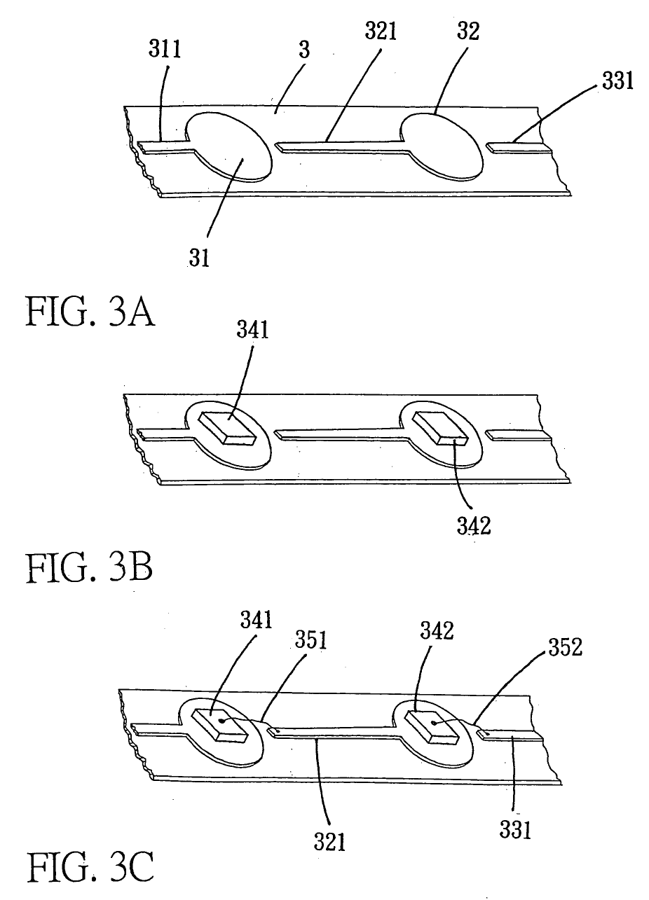

FIGS. 3A to 3F are the schematic views illustrating the fabrication steps in a third embodiment, it comprises the steps:
Step 1: Fabricating an elongated substrate 3 firstly, it is a LED substrate made of a soft insulated material such as a PC board, and then disposing several electrodes 31, 32 . . . longitudinally on the PC board with printed wires.
Step 2: Extending extension portions 311, 321, 331 in the same direction from each of the electrodes 31 (32), and installing a LED unpacked chip or original element 341 (342) on each electrode 31 (32) . . .
Step 3: Connecting each LED unpacked chip or original element 341 (342) with the adjacent extension portion 321 (331) with a welding wire 351 (352) to form a string of lighting source.
Step 4: Enclosing the lighting source with a soft fixing material 36.
Step 5: Preparing another power supply busbar 37 in parallel to the string of lighting source, and connecting the multi-polar or multi-circuit busbars 37 together with connectors 38 so as to obtain a variety of elongated lighting effects.
Step 6: Enclosing the structure completed in the above steps with an inner insulation housing 39.

The aforesaid fixing material 36 may be a soft heat shrink material to cover and fix the string of lighting source by heating, or may be a soft adhering tape to fix the string of lighting source by taping, The fixing material 36 may be transparent or semi-transparent, mono-colored or multi-colored, uni-patterned or multi-patterned, and a fluorescent material may be added if desired.

The elongated substrate 3 is made of an elongated soft insulated material which is a longitudinally extruded mono- or multi-colored plastic transparent, or semi-transparent material. The plastic may be either PVE or PVC, and may be filled with a fluorescent material if desired.

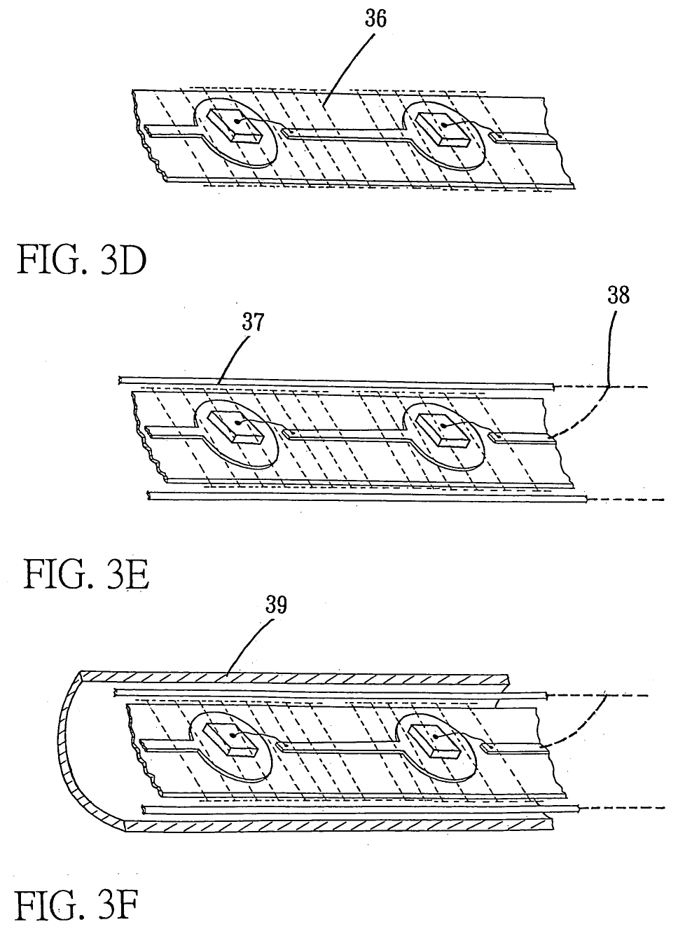

FIG. 4 shows a fourth embodiment of the present invention. In this embodiment, the LED unpacked chips or their original elements 41 are successively set on an elongated LED substrate 4 which has two electrodes 43, 44 isolated by an insulation surface 42. The electrode 43 has a concavity 45 as a chip holder for the LED unpacked chip or the original element 41 to set in, and the inner surface of the concavity 45 is coated with a reflection material. The electrode 43 is directly connected to one terminal of the LED unpacked chip or its original element 41 set in the concavity 45, while the other terminal thereof is connected to the other electrode 44 with a welding wire 46.

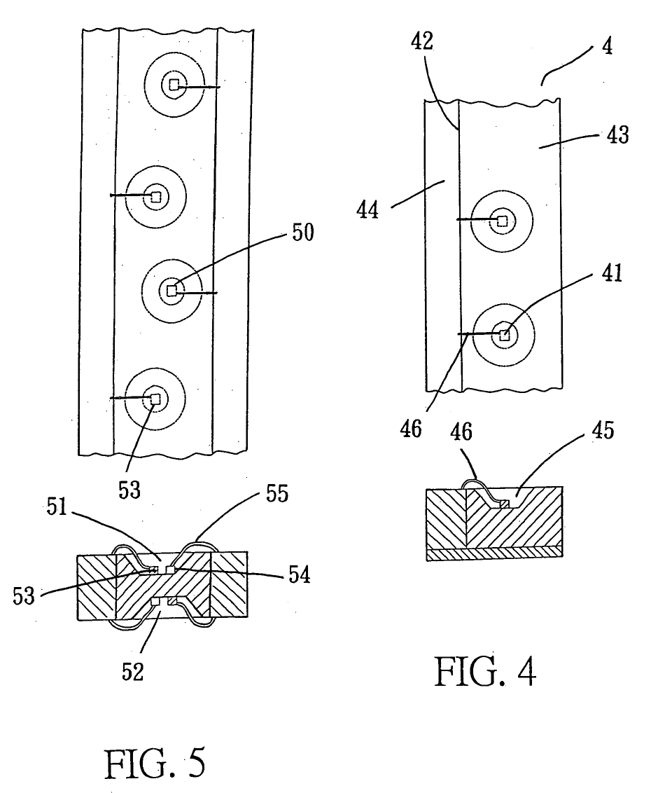

FIG. 5 shows a fifth embodiment of the present invention. In this embodiment, several concavities 51, 52 are formed along the upper and the lower surfaces of the elongated LED substrate 5. Several LED unpacked chips or their original elements 53, 54 are disposed staggeredly in the longitudinal direction on the concavities 51, 52, and connected to the electrode of the elongated LED substrate 5 with welding wires 55 so as to form strings of lighting source on both face, besides, the inner surfaces of the concavities 51, 52 are coated with a reflection material.

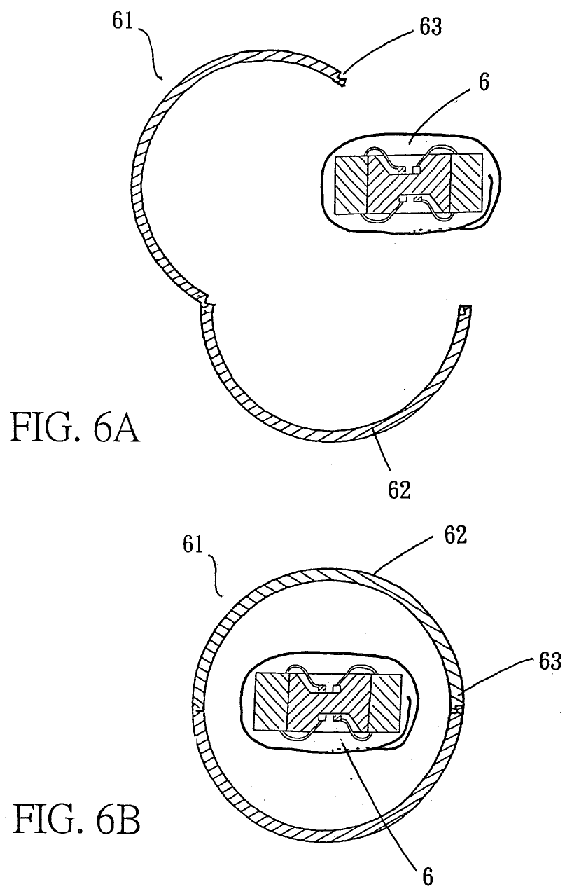

FIGS. 6A and 6B show a sixth embodiment of the present invention. In this embodiment, a two-face string of lighting source is formed on an elongated LED substrate 6, and this structure is enclosed by an inner insulation housing serving as a fixing material 61 and extends an extension sleeve 62 in the lengthwise direction which encloses intermittently or successively the string of lighting source, each junction of the extension sleeve 62 is linked by a retainer 63.

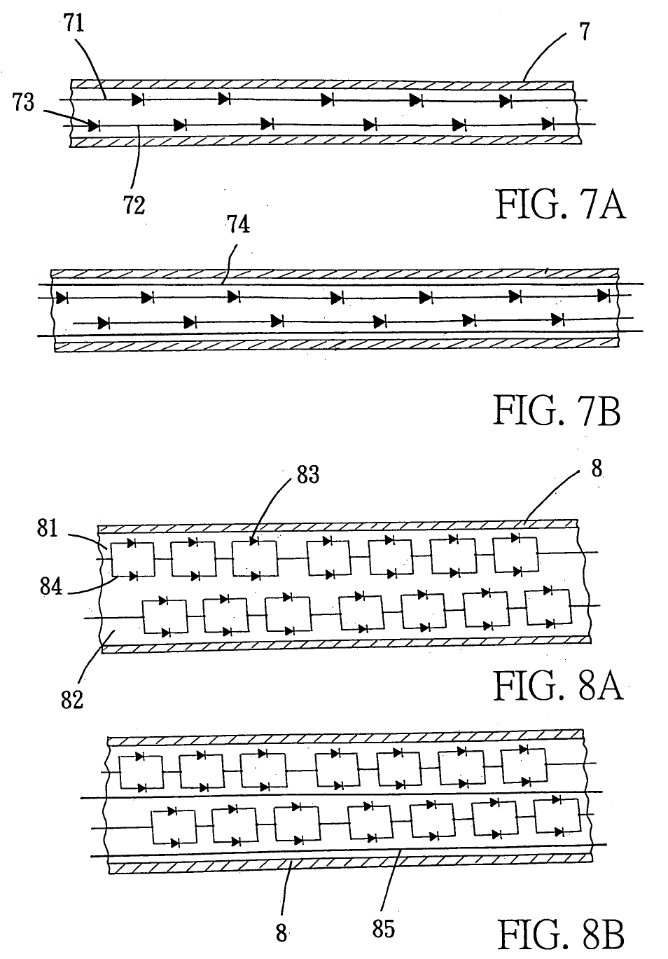

FIGS. 7A and 7B show a seventh embodiment of the present invention. In this embodiment, two units of lighting source string 71, 72 is disposed in parallel in an insulation housing 7, each of the two units 71, 72 is composed of several LED unpacked chips or their original elements 73 connected in series, afterwards, a busbar 74 is provided in the insulation housing 7,

wherein the LED unpacked chips or their original elements 73 may be disposed in the form like scattered spots, meandering lines, or spreaded planes, also they may be grouped in a variety of configuration emitting similar or different colors. The conductors used for connection may be bare or insulated. The insulation housing 7 may be a soft plastic insulated material longitudinally extruded into a transparent, semi-transparent, mono-colored, or multi-colored structure. The plastic material may be PVE, PVC, or their mixture, and a fluorescent material may be added if desired.

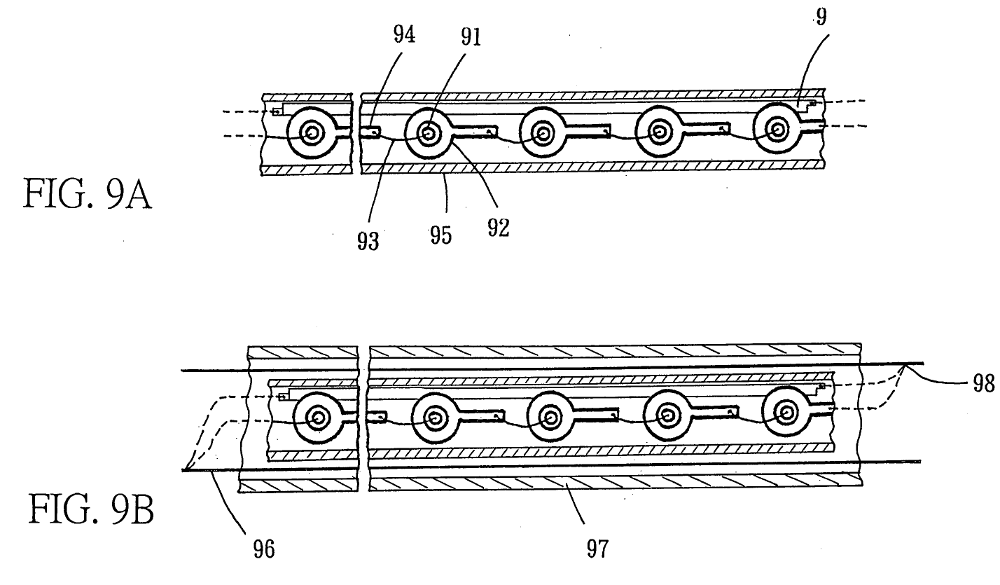

FIGS. 8A and 8B show the eighth embodiment of the present invention. In this embodiment, the entire construction is approximately similar to that of FIG. 7 unless strings of lighting source 81, 82 in the insulation housing 8 are composed of several LED unpacked chips or their original elements 83 which at first being connected in parallel to form a small group of lighting source 84 and then the groups 84 are connected in series with conductors to configurate in an array, and thereafter a busbar 85 is provided within the insulation housing 8.

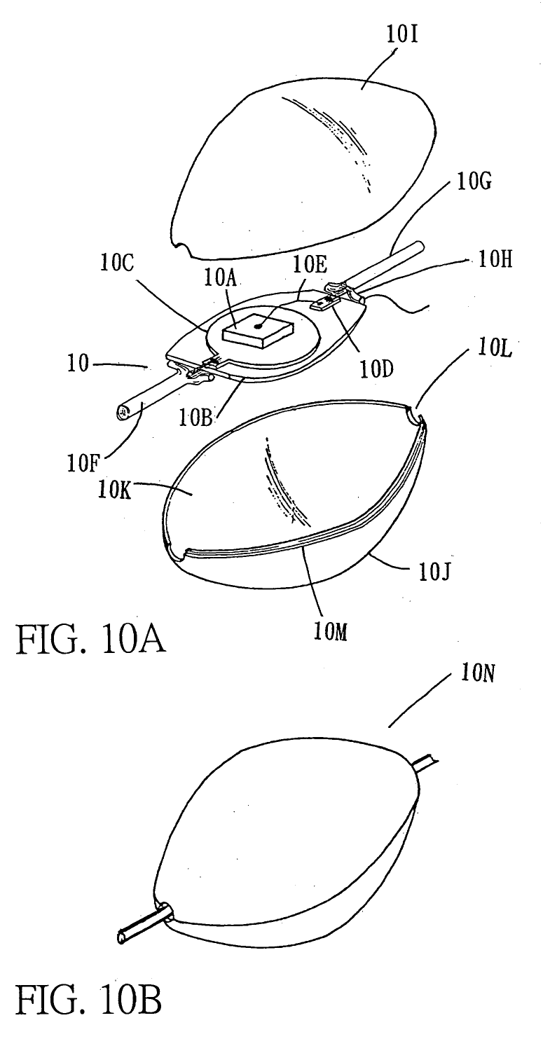

FIGS. 9A and 9B show a ninth embodiment of the present insulation. In this embodiment, several LED unpacked chips and their original element 91 are connected in string and set in an elongated LED substrate 9 with its one terminal directly connected to an electrode 92 of the LED substrate 9, with a welding wire 93, wherein the elongated LED substrate 9 is made of an insulated material, and the string of lighting source is enclosed with an insulation inner housing 95. A power supply busbar 96 is provided in the LED substrate 9 in parallel to the lighting source serving as power supply connection for terminals of the lighting source. Moreover; a soft elongated flexible insulation outer housing 97 is employed to enclose and protect the string of lighting source and the busbar 96, and an additional connection means 98 is provided in the inner housing 95 for a station of conductor connection therefore completing an elongated lighting equipment capable of exhibiting a variety of lighting effects.

The lighting element may be an unpacked chip or its original element of LED OLED, EL, or OEL configurated into a single plane, a multi-plane, or even a three-dimensional contour. The applied voltage on both electrodes connected to the power supply busbar with conductors is approximately equal to that on the two terminals of the grouped lighting source.

The substrate may be a PC board with printed wires to form the electrodes. The substrate may be transparent, semi-transparent, or colored. The inner and outer insulation housing are both made of a plastic material (PVC, PVE, or mixture thereof) of transparent, semi-transparent, various colored, or even fluorescent material added formed by extrusion in the longitudinal direction. The way of conductor connection may be taping with an adhesive tape, welding, or compression, the conductor may be bare or insulated.

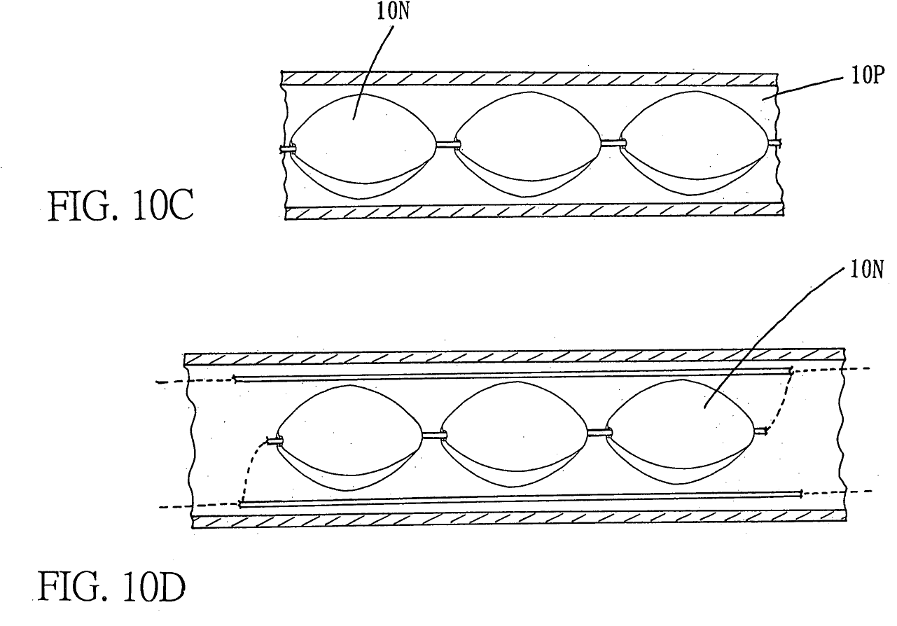

FIGS. 10A to 10D are the schematic views illustrating the fabrication steps in a tenth embodiment. In this embodiment, A LED unpacked chip or its original element 10A is set on a unit substrate 10B which has two electrodes 10C, 10D. One electrode 10C has the LED unpacked chip or its original element 10A entraining on it, and one terminal of 10A is connected to the electrode 10D of the substrate 10B with a welding wire 10E. Two insulated conductors 10F and 10G are connected together in a straight line (180° apart) from two sides of the substrate 10B. The front jointed terminals of the two insulation conductors 10F, 10G with the substrate 10B cambered back and bifurcated to form two open ports 10H to allow the center bare conductors to connect with the electrodes 10C, 10D thereby forming a string of lighting source 10. Two envelopes 10I, 10J provided for enclosing the string of light 10 are two hollow concavities each having an inner hollow part 10K. Each envelope 10I (10J) is provided with two openings 10L to accept the insulation conductors 10F, 10G and retain the cambered insulation thereof at the bifurcated portion. Besides, the edges of the two envelopes 10I, 10J are formed into retainers to engage with each other firmly, or enhance engagement by applying a binder if desired. In this way, a LED lighting unit 10N is completed. After completing assembly of the LED lighting unit 10N, several units 10N are connected in series on an elongated substrate 10P by interconnecting all electrodes and enclosed with an insulation housing so as to complete a string of LED lighting source.

The two envelopes 10I, 10J may be made of a material of transparent, semi-transparent, or multi-colored, filled with a fluorescent material, if desired. Its contour may be predetermined regular, or irregular; similar or different configuration, enclosed with a fixing material after the string of the lighting source is completed.

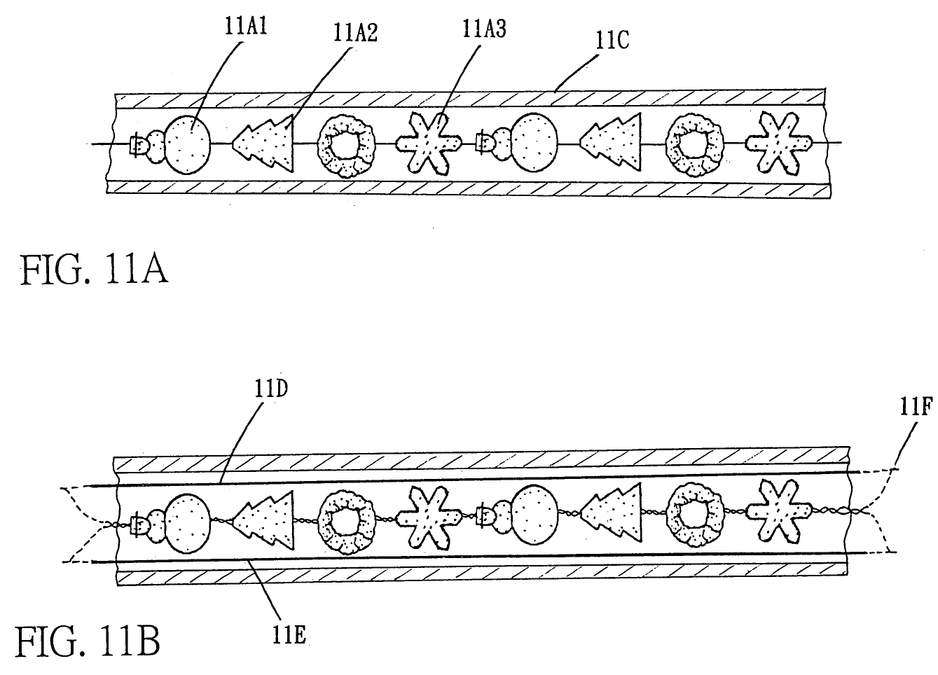

FIGS. 11A and 11B show an 11^{th} embodiment of the present invention. In this embodiment, it comprises a plurality of units LED 11A1, 11A2, 11A3 with regular or irregular, similar or different contour, or connected in series, parallel, or series-parallel with two terminals for electrical connection.

An insulation housing 11C is made of a soft insulated material of transparent, semi-transparent, or multi-colored, or filled with a fluorescent material if desired.

Two power supply busbars 11D, 11E formed of several similar pole, or different pole electrical conductors laid in parallel with the string of lighting source provide the electrical connection for the terminals of the string of the lighting source.

A connecting means 11F provided at the end portion of the main body of lighting source with a predetermined length can be connected to multiple power sources and enable the elongated lighting equipment to exhibit a variety of lighting effects.

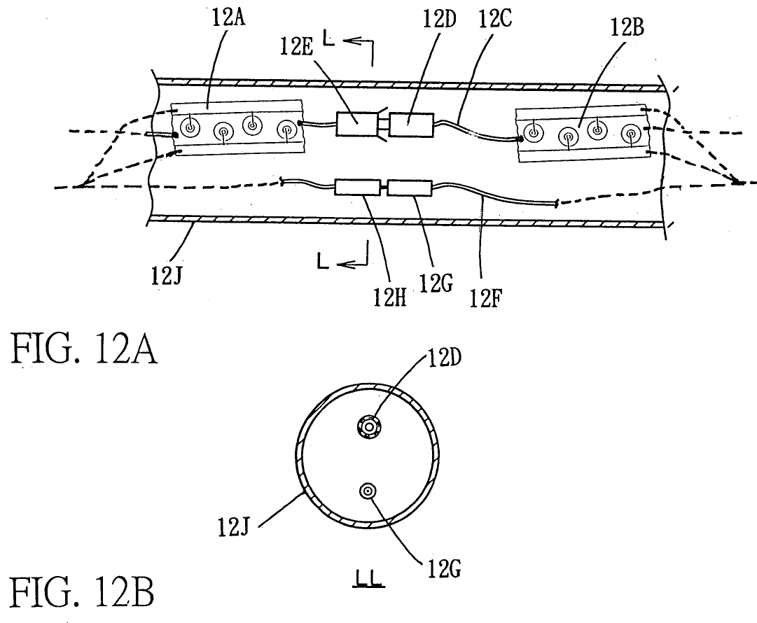

FIGS. 12A and 12B show a 12^{th} embodiment of the present invention. In this embodiment, it comprises a plurality of lighting elements connected in series, parallel, or series-parallel to form strings of LED lighting source 12A, 12B with their both terminals for electrical connection.

An electrical conductor 12C is provided to interconnect the LED lighting sources 12A and 12B. Each section of conductor 12C is provided with a male connector 12D ad a female connector 12E so as to discriminate the different electric poles when making connection.

A power supply busbar 12F formed of several conductors of similar or different polarity which being laid in parallel to the strings of light source 12A, 12B is also provided with a male connector 12G and a female connector 12H at each connecting section so as to discriminate the different electric polarity when making connection.

A soft insulation outer housing 12J is provided for enclosing and protecting both the string of lighting source and the busbar 12F and forms an elongated flexible main body.

The male connectors 12D, 12G and the female connectors 12E, 12H can be made in different size and shape.

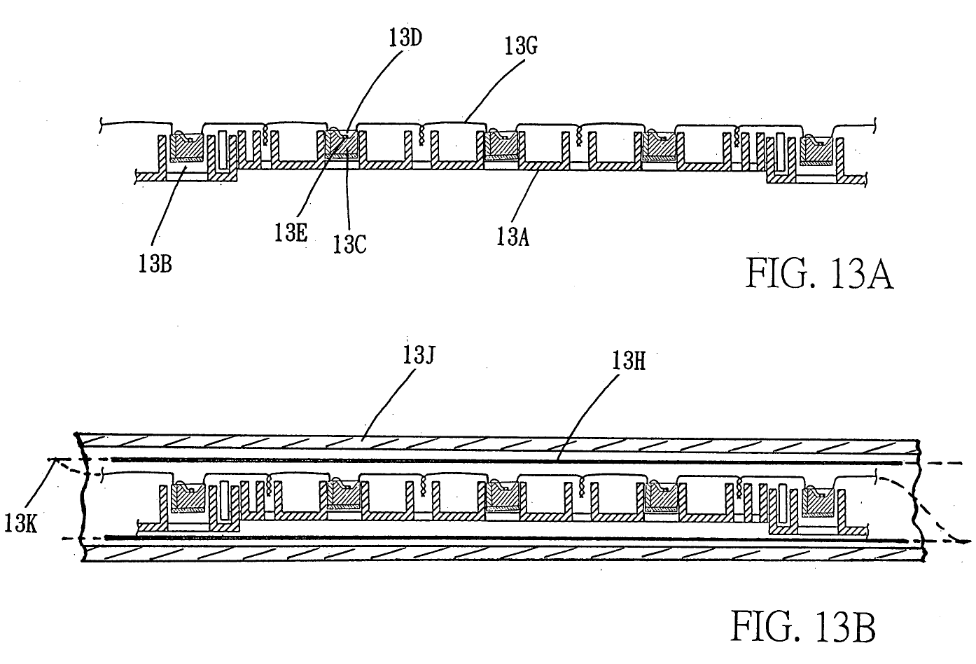

FIGS. 13A and 13B show a 13^{th} embodiment of the present invention. In this embodiment, it comprises several bases 13A with a hole 13B formed between adjacent bases 13A for accommodating a substrate 13C.

A concavity 13D is formed on each substrate 13C for accommodating a LED lighting element 13E, and the inner surface of each concavity 13D is coated with a reflection material.

The plurality of LED lighting elements 13E connected in series, parallel, or series-parallel has two terminals for electrical connection.

A fixing material made of soft tape has several spacing for the substrate to insert into, and fix part of the string by taping.

Several insulation or bare conductors 13G provide electrical connection between the substrates, each connected section may be bound with taping.

A power supply busbar 13H formed of several conductors of similar or different polarity which being laid in parallel to the strings of lighting source is for electrical connection for the terminals of the string of lighting source.

A soft outer insulation housing 13J is provided for enclosing and protecting both the string of lighting source and the busbar 13H and forms an elongated flexible main body.

A connecting means 13K provided at the end portion of the main body of the lighting source with a predetermined length can be connected to multiple power sources and enable the elongated lighting equipment to exhibit a variety of lighting effects.

The substrate may be made of a transparent, semi-transparent, or colored material.

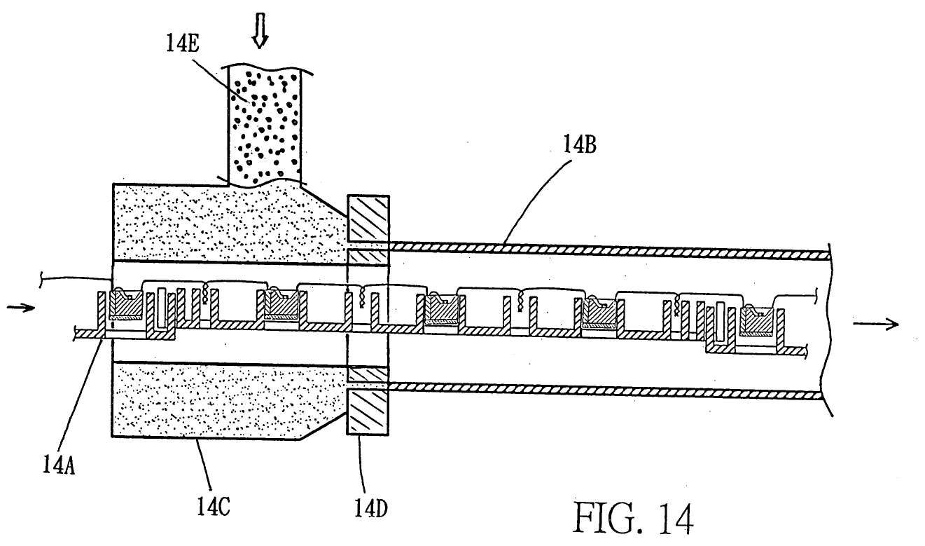

FIG. 14 shows a schematic view illustrating the procedure of enclosing an insulation inner housing 14B on a string of lighting equipment 14A of the present invention. After finishing the assembly of the lighting equipment 14A as shown in FIG. 13, the lighting equipment 14C is sent into an extruder 14C having a die block 14D from its one end, and plastic granules 14E are fed into the extruder 14C from its upper end. A plastic enclosed lighting equipment is obtained after the plastic granules 14E are melted thus completing the fabrication of the main body of flexible lighting equipment enclosed in an inner insulation housing.

After connecting the strings of lighting source in series, a plurality of envelopes is used to enclose the strings of lighting source in their hollow spacings. A plastic outer solid or hollow housing is formed by extrusion process employing variously shaped die blocks.

The rugged inner or outer surface of the finished plastic housing due to different die blocks creates a diffused reflection effect of light, and the lateral cross section of the outer housing can be formed into a circular, semi-circular, polygonal, or other predetermined shape.

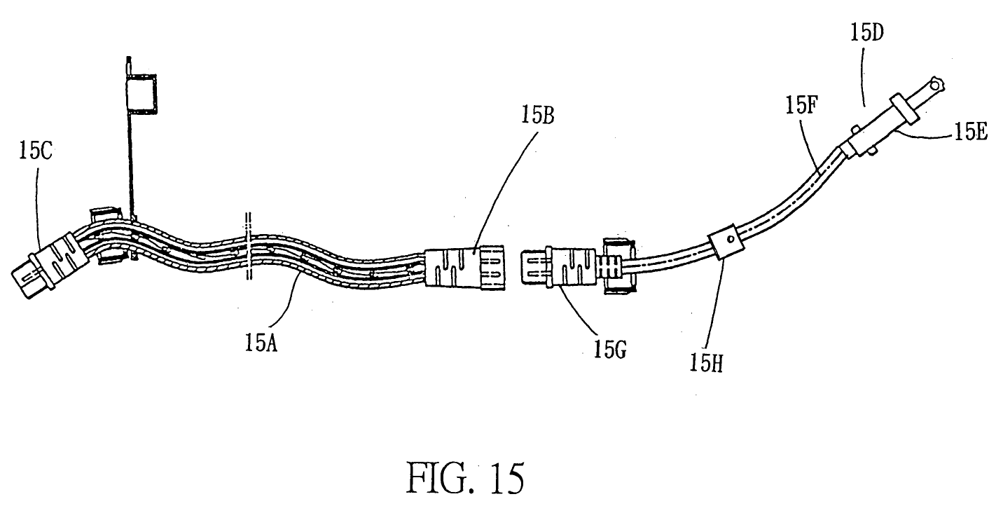

FIG. 15 shows a planar view of a 14^{th} embodiment. In this embodiment, a male connector 15B and a female connector 15C are provided at the end portion of the flexible main body 15A for electrical connection.

A power supply device 15D including a plug 15E at the source terminal and a female connector 15G at the load terminal with an insulation conductor 15F connected therebetween is for supplying power to the lighting equipment by mating the female connector 15G with the male connector 15B.

A function controller provided at the middle portion of the insulation conductor 15F is functional for voltage transformation, rectification, on/off switching, quick/slow, variation control, and dimming.

From the above examples, it is clearly understood that the elongated flexible lighting equipment is easy to fabricate, and creating any desired configuration for the lighting equipment by connecting the strings of lighting source in series, parallel, or series-parallel, or by flexing the main body of the lighting equipment. In addition, the transparent, semi-transparent, or various shaped substrate assists to increase the lighting effect.

Those who are skilled in the art will readily perceive how to modify the invention. Therefore, the appended claims are to be construed to cover all equivalent structures which fall within the true scope and spirit of the invention.

1. An elongated flexible lighting equipment comprising:
a plurality of non-vacuum or non-gas filled lighting elements connected in series, parallel, or series-parallel string of lighting source with connecting means for electrical connection provided at both terminals;
a power supply busbar formed of several electrical conductors of same or different polarity disposed in parallel to said string of lighting source for electrical connection with both terminals of said string of lighting source;
a soft outer insulation housing for enclosing and protecting said string of lighting source and said busbar to form a main body of said elongated flexible lighting equipment; and a connecting means provided at each end portion of said main body of predetermined length for making electrical connection of multi-polarity or multi-circuit power system thereby completing said elongated flexible lighting equipment having various predetermined lighting effects.

2. The lighting equipment of claim 1, wherein said non-vacuum and non-gas filled lighting element is a LED, an OLED, an EL, or an OEL in unpacked chip or an original element.

3. The lighting equipment of claim 2, wherein said lighting elements are disposed in scattered spots, meandering lines, or spreaded planes.

4. The lighting equipment of claim 1 or 3, wherein said lighting elements are disposed in an array configuration.

5. The lighting equipment of claim 1, wherein said lighting elements are disposed in the figure of a single plane, multi-planes, or a three-dimensional contour.

6. The lighting equipment of claim 1, wherein said lighting elements are configurated in strings of various patterns, the voltage applied between said power supply busbar to either terminal is approximately equal.

7. The lighting equipment of claim 1 or 6, wherein said lighting elements are of similar or different color.

8. The lighting equipment of claim 1, wherein said lighting elements are LED unpacked chips or the original elements connected together and set in an elongated substrate, both terminals thereof are connected to the corresponding electrodes of said substrate.

9. The elongated lighting equipment of claim 1 or 8, wherein at least one terminal of the LED is directly connected to one electrode of said substrate, while at least one of the other terminals is connected to the outer electrode of said substrate with a welding wire.

10. The elongated lighting equipment of claim 1 or 8, wherein said elongated LED substrate is made of a soft elongated insulated material.

11. The elongated lighting equipment of claim 1, wherein said substrate is a PC board.

12. The elongated lighting equipment of claim 1 or 11, wherein the electrodes of said PC board are formed of printed wires.

13. The elongated lighting equipment of claim 1 or 8, wherein said substrate is transparent, semi-transparent, or colored.

14. The elongated lighting equipment of claim 1 or 8, wherein several concavities are formed in said insulated material so as to accommodate said LED chips.

15. The elongated lighting equipment of claim 1, wherein the inner surfaces of said concavities serving as chip holders are coated with a reflection substance.

16. The elongated lighting equipment of claim 1, wherein said LED unpacked chip or its original element is combined with, and set in said substrate to form an unit lighting element, with terminals of said units connected to the electrodes of said substrate and then a plurality of such units of lighting element is connected together with the terminals and disposed on said elongated substrate so as to form said string of lighting source.

17. The elongated lighting equipment of claim 1 or 16, wherein at least one terminal of the LED is directly connected to one electrode of said substrate while at least one of the other terminals is connected to the other electrode of said substrate with a welding wire.

18. The elongated lighting equipment of claim 1 or 16, wherein said elongated substrate is made of a soft material.

19. The elongated lighting source of claim 1 or 16, wherein said elongated substrate is formed of an elongated soft OLED, EL, or OEL.

20. The elongated lighting source of claim 1, wherein both terminals of said elongated OLED, EL, or OEL are connected to said power supply busbar with an electric conductor, wherein its applied voltage is approximately equal to that applied to both terminals of said multiply connected lighting elements.

21. The elongated lighting equipment of claim 1, wherein said string of lighting source is enclosed with a soft fixing material.

22. The elongated lighting equipment of claim 1 or 21, wherein said fixing material is a soft heat shrink material which is heat shrinkable to fix said string of lighting source with a sleeve.

23. The elongated lighting equipment of claim 1 or 21, wherein said fixing material is a soft adhesive tape to fix said string of lighting source by taping.

24. The elongated lighting equipment of claim 1 or 21, wherein said fixing material holds said string at intervals, or continuously.

25. The elongated lighting equipment of claim 1 or 21, wherein said fixing material is transparent, or semi-transparent, mono or multi-colored, single or multi-patterned, or being filled with a fluorescent material if desired.

26. The elongated lighting equipment of claim 1, wherein said electrical connection is made of taping, welding, or compressing.

27. The elongated lighting equipment of claim 1, wherein the conductor used for electrical connection is a bare or an insulated conductor.

28. The elongated lighting equipment of claim 1, wherein said soft outer insulation housing is formed of a plastic material extruded longitudinally, and said plastic material is transparent or semi-transparent, mono or multi-colored, being filled with a fluorescent material if desired.

29. The elongated lighting equipment of claim 1 or 28, wherein said plastic material is a mixture of PVE or PVC.

30. The elongated lighting equipment of claim 1, wherein a male connector and a female connector are each respectively provided one of the terminals of said flexible main body for electrical connection.

31. An elongated flexible lighting equipment comprising:
a plurality of non-vacuum or non-gas filled lighting elements connected in series, parallel, or series-parallel string of lighting source with connecting means for electrical connection provided at both terminals;
a power supply busbar formed of several electrical conductors of same or different polarity disposed in parallel to said string of lighting source for electrical connection with both terminals of said string of lighting source;
a soft outer insulation housing for enclosing and protecting said string of lighting source and said busbar to form a main body of said elongated flexible lighting equipment;
a connecting means provided at each end portion of said main body of predetermined length for making electrical connection with multi-polarity or multi-circuit power system using a male and a female connectors;
a power supply device including a plug connector and a function controller interconnected with an insulation conductor therebetween, and then connected to connecting means of said main body, afterwards a variety of elongated lighting effects can be achieved when said power supply device is energized.

32. The lighting equipment of claim 31, wherein a connector unit containing a male and a female connectors for connecting with a similar connector unit of another string of light source can be built in said outer insulation housing.

33. The lighting equipment of claim 32, wherein said connector unit discriminates the corresponding polarity of the other side by specified configuration.

34. The lighting equipment of claim 31, wherein said power supply device is using said plug for connecting with said insulation conductor at one side, while the other side is mated to the male connector of said flexible main body with said female connector.

35. The lighting equipment of claim 31, wherein said function controller is provided between said connector unit and said flexible main body and is interconnected with an insulation conductor.

36. The lighting equipment of claim 31, wherein said function controller is functional for voltage transformation, rectification, on/off switching, quick/slow control, and dimming.

37. An elongated flexible lighting equipment comprising:
a plurality of non-vacuum or non-gas filled lighting elements connected in series, parallel, or series-parallel string of lighting source with connecting means for electrical connection provided at both terminals;
an inner insulation housing for enclosing and protecting said string of lighting source; a power supply busbar formed of several conductors of similar or different polarity disposed in parallel to said string of lighting source for electrical connection with both terminals of said string of lighting source;
a soft outer insulation housing for enclosing and protecting said string of lighting source and said busbar to form a main body of said elongated flexible lighting equipment; and a connecting means provided at each end portion of said main body of predetermined length for making electrical connection of multi-polarity or multi-circuit power system thereby completing said elongated flexible lighting equipment having various predetermined lighting effects.

38. The lighting equipment of claim 37, wherein said non-vacuum and non-gas filled lighting element is a LED, an OLED, an EL, or an OEL in unpacked chip or an original element.

39. The lighting equipment of claim 37 or 38, wherein said lighting elements are disposed in scattered spots, meandering lines, or spreaded planes.

40. The lighting equipment of claim 37, wherein said lighting elements are disposed in an array configuration.

41. The lighting equipment of claim 37, wherein said lighting elements are disposed in the figure of a single plane, multi-planes, or a three-dimensional contour.

42. The lighting equipment of claim 37, wherein said lighting elements are configurated strings of various patterns, the voltage applied between said power supply busbar to either terminal is approximately equal.

43. The lighting equipment of claim 37 or 42, wherein said lighting elements are of similar or different color.

44. The lighting equipment of claim 37, wherein said lighting elements are LED unpacked chips or the original elements connected together and set in an elongated substrate, both terminals thereof are connected to the corresponding electrodes of said substrate.

45. The lighting equipment of claim 37 or 44, wherein at least one terminal of the LED is directly connected to one electrode of said substrate, while at least one of the other terminals is connected to the other electrode of said substrate with a welding wire.

46. The lighting equipment of claim 37 or 44, wherein said elongated LED substrate is made of a soft elongated insulated material.

47. The lighting equipment of claim 37, wherein said substrate is a PC board.

48. The lighting equipment of claim 37, wherein the electrodes of said PC board are formed of printed wires.

49. The lighting equipment of claim 37 or 44, wherein said substrate is transparent, semi-transparent, or colored.

50. The lighting equipment of claim 37 or 44, wherein several concavities are formed in said insulated material so as to accommodate said LED chips.

51. The lighting equipment of claim 37, wherein the inner surfaces of said concavities serving as chip holders are coated with a reflection substance.

52. The lighting equipment of claim 37, wherein said LED unpacked chip or its original element is combined with and set in said substrate to form an unit lighting element, with terminals of said units connected to the electrodes of substrate and then a plurality of such units of lighting element is connected together with the terminals and disposed on said elongated substrate so as to form said string of lighting source.

53. The lighting equipment of claim 37 or 52, wherein at least one terminal of the LED is directly connected to one electrode of said substrate, while at least one of the other terminals is connected to the other electrode of said substrate with a welding wire.

54. The lighting equipment of claim 37 or 52, wherein said elongated substrate is made of a soft material.

55. The lighting equipment of claim 37 or 52, wherein said elongated substrate is formed of an elongated soft OLED, EL, or OEL.

56. The lighting equipment of claim 37, wherein both terminals of said elongated OLED, EL, or OEL are connected to said power supply busbar with an electric conductor, wherein its applied voltage is approximately equal to that applied to both terminals of said multiply connected lighting elements.

57. The lighting equipment of claim 37, wherein said soft inner insulation housing is formed of a plastic material extruded longitudinally, and said plastic material is transparent, or semi-transparent, mono or multi-colored, being filled with a fluorescent material if desired.

58. The lighting equipment of claim 57, wherein said plastic material is a mixture of PVE or PVC.

59. The lighting equipment of claim 57, wherein said inner insulation housing is formed of several EL hollow envelopes assembled to enclose said string of lighting source.

60. The lighting equipment of claim 59, wherein said assembly of several envelops reserves an opening for letting through an insulation conductor.

61. The lighting equipment of claim 59, wherein the edges of said envelopes are formed into retainers to grip conductors or insulated material.

62. The lighting equipment of claim 59, wherein the edges of said envelopes are formed into retainers to engage with each other.

63. The lighting equipment of claim 37, wherein said inner insulation housing is formed of a plastic material of a transparent, semi-transparent, or multi-colored being filled with a fluorescent material if desired.

64. The lighting equipment of claim 37, wherein said inner insulation housing is configurated in regular, irregular, similar, or different contour.

65. The lighting equipment of claim 37, wherein said inner insulation housing is a sleeve extended in longitudinal direction and wrapping said string of lighting source at intervals or successively.

66. The lighting equipment of claim 65, wherein said sleeve is composed of a plurality of component parts with their edges formed into retainers so as to mate said component parts together.

67. The lighting equipment of claim 37, wherein said electrical connection is achieved by taping, welding, or compression.

68. The lighting equipment of claim 37, wherein said electrical connection is made of bare conductors or insulation conductors.

69. The lighting equipment of claim 37, wherein said soft outer insulation housing is formed of a plastic material extruded longitudinally, and said plastic material is transparent, or semi-transparent, mono or multi-colored, being filled with a fluorescent material if desired.

70. The lighting equipment of claim 37 or 69, where said plastic material is a mixture of PVE or PVC.

71. The lighting equipment of claim 37, wherein said connecting means is a male and a female connector provided at each of the two terminals of said flexible main body.

72. An elongated flexible lighting equipment comprising:
a plurality of non-vacuum or non-gas filled lighting elements connected in series, parallel, or series-parallel string of lighting source with connecting means for electrical connection provided at both terminals;
a power supply busbar formed of several conductors of similar or different polarity disposed in parallel to said string of lighting source for electrical connection with both terminals of said string of lighting source;
a soft outer insulation housing for enclosing and protecting said string of lighting source and said busbar to form a main body of said elongated flexible lighting equipment;
a connecting means provided at each end portion of said main body of predetermined length for making electrical connection with multi-polarity or multi-circuit power system using said male and female connectors; and
a power supply device including a plug connector and a function controller interconnected with an insulation conductor therebetween and then connected to connecting means of said main body, afterwards, a variety of elongated lighting effects can be achieved when said power supply device is energized.

73. The lighting equipment of claim 72, wherein a connector unit containing a male and a female connector for connecting with a similar connector unit of another string of light source can be built in said outer insulation housing.

74. The lighting equipment of claim 73, wherein said connector unit discriminates the corresponding polarity of the other side by specified configuration.

75. The lighting equipment of claim 72, wherein said power supply device is employing said plug for connecting with said insulation connector at one side, while the other side is mated to the male connector of said flexible main body with said female connector.

76. The lighting equipment of claim 72, wherein said function controller is provided between said connector unit and said flexible main body and is interconnected with an insulation conductor.

77. The lighting equipment of claim 72, wherein said function controller is functional for voltage transformation, rectification, on/off switching, quick/slow control, and dimming.

78. A fabrication method of an elongated flexible lighting equipment, comprising the steps:
connecting a plurality of non-vacuum or non-gas filled lighting elements in series, parallel, or series-parallel with conductors to form a string of lighting source with electrical connection means provided at its both terminals thereof;
disposing a power supply busbar formed of several conductors of similar or different polarity in parallel to said string of lighting source for connecting both terminals of said string of lighting source to preformed electrodes;
enclosing said string of lighting source with a soft PVC insulation material using a plastic extrusion press with a specific die block so as to form a flexible main body of lighting equipment enclosed in an insulation housing.

79. The fabricating method of claim 78, wherein said LED unpacked chips or its original element with multi-polarity is disposed on a predetermined position of said elongated substrate being provided with electric circuits, at least one pole, thereof is connected with one electrode of said substrate, while at least one of the rest poles is connected to the other electrode of said substrate with a welding wire, and then formed into said strings of lighting source by connecting in series, parallel, or series-parallel according to a predetermined circuit pattern.

80. The fabrication method of claim 78, wherein said LED unpacked chip or its original element with multi-polarity is disposed on a multi-polared single substrate, at least one pole thereof is connected with one electrode of said substrate, while at least one of the rest poles is connected to the other electrode of said substrate with a welding wire, and then formed into said strings of lighting source by connecting in series, parallel, or series-parallel by connecting corresponding electrodes of each substrate with conductors according to a predetermined circuit pattern.

81. The fabrication method of claim 78, wherein said lighting equipment is enclosed with a fixing material after it is connected in string.

82. The fabrication method of claim 78, wherein after forming said lighting string, it is enclosed and sealed with an inner insulation housing formed of a plastic material extruded longitudinally using a plastic extrusion press with a specific die block.

83. The fabrication method of claim 78, wherein after forming said lighting string, it is enclosed in the hollow portion of an enclosure assembled by a plurality of component envelopes.

84. The fabrication method of claim 78, wherein said specified die block is configurated in various shapes so that it can be used to form a solid or hollow outer insulation housing by extrusion process.

85. The fabrication method of claim 78, wherein said specified die block is configurated in various shapes such that said plastic insulation housing has a rugged inner or outer edge with various types of light reflection and refraction effects.

86. The fabrication method of claim 78, wherein said specified die block is configurated in various shapes such that the plastic outer insulation housing can be configurated into a circular, a semi-circular, a polygonal or other predetermined contour.

87. The fabrication method of claim 78, wherein each terminal of said flexible main body is provided wit a male and a female connector for electrical connection.

88. The fabrication method of claim 78, wherein said power supply device is provided with a plug at one terminal, and a female connector at the other terminal so as to be connected with a male connector of said main body with an insulation conductor for supplying power to said lighting equipment.
